(19) United States
(12) Patent Application Publication
(10) Pub. No.: US 2014/0226435 A1
(43) Pub. Date: Aug. 14, 2014

(54) STIRRING AND TRANSPORT DEVICE FOR POULTRY DROPPINGS

(71) Applicant: HYTEM CO., LTD., Gifu (JP)

(72) Inventor: Toshimi ANDO, Kakamigahara-shi (JP)

(73) Assignee: HYTEM CO., LTD., Gifu (JP)

(21) Appl. No.: 14/254,601

(22) Filed: Apr. 16, 2014

Related U.S. Application Data
(63) Continuation of application No. PCT/JP2011/077400, filed on Nov. 28, 2011.

(51) Int. Cl. B01F 7/00

(52) U.S. Cl. CPC B01F 7/00883
USPC 366/297

(57) ABSTRACT

A stirring and transport device for poultry droppings includes a first screw having spiral screw blades, a second screw formed to have a shape symmetric to the first screw, a long groove-like trough having a poultry manure conveyance space, a wet manure charge port through which wet manure collected from a poultry cage is charged into the poultry manure conveyance space, a dry manure charge port through which dry manure is charged into the poultry manure conveyance space, a poultry manure discharge port through which poultry manure obtained by mixing the wet manure and the dry manure is discharged from the poultry manure conveyance space, and a rotating mechanism unit that rotates two screws and conveys the wet manure and the dry manure to the poultry manure discharge port while agitating the wet manure and the dry manure in the poultry manure conveyance space.

### CROSS REFERENCE TO RELATED APPLICATIONS

This application is a continuation of International Application No. PCT/JP2011/077400 filed on Nov. 28, 2011, of which full contents are incorporated herein by reference.

### BACKGROUND OF THE INVENTION

1. Field of the Invention

The present invention relates to a stirring and transport device for poultry droppings. In particular, the invention relates to a stirring and transport device for poultry droppings that is capable of adjusting a moisture content of poultry manure (droppings) while the poultry manure collected from a poultry cage for breeding a large number of chickens is conveyed to a drying apparatus that dries the poultry manure for reuse as fertilizer and fuel.

2. Description of the Related Art

Poultry manure collected from a large number of chickens housed in a poultry cage is reused as fertilizer or fuel. The poultry manure immediately after being excreted from the chickens and collected is in a paste form containing a large amount of moisture, so that it is not appropriate for being used as the fertilizer or the like as it is. Further, there is the following problem or the like in storing the poultry manure having a high moisture content. That is, the poultry manure having the high moisture content spreads odor to the periphery, propagates bacteria, or generates a large amount of pests such as flies. In order to solve the problem, the following drying processing is performed on the poultry manure having the high moisture content immediately after being collected (hereinafter, referred to as “wet manure”). That is, the drying processing of making the wet manure contact with the heated air and evaporating the moisture in the wet manure so as to obtain poultry manure dried to have equal to or lower than a defined moisture content (hereinafter, referred to as “dry manure”) is performed. With this, for example, the “wet manure” having the moisture content of equal to or higher than 70% immediately after being collected can be converted to the “dry manure” having the moisture content of equal to or lower than 20%. That is, the poultry manure can be made into a state appropriate for being reused for various applications such as the fertilizer and the fuel. Further, the moisture content is lowered so as to solve the above-mentioned problem relating to storage. In addition, the poultry manure overall can be reduced in weight and capacity, thereby obtaining advantages that a space required for storage can be reduced and a cost at the time of transportation can be reduced.

A drying apparatus that dries the poultry manure efficiently has been proposed (see, Japanese Patent No. 3743766). The drying apparatus mainly includes a base in which plate-like elements made of a material having air permeability are arranged so as to be separated from each other at the upper and lower sides, hole portions that are provided on the upper and lower elements so as not to be identical in the vertical direction, and a scraper deck that is inserted between the upper and lower two elements and is slidable in the horizontal direction. With this configuration, the poultry manure charged into the base is pressed out by the scraper deck in the horizontal direction and drops on the lower element through the hole portions provided on the element. In this case, moisture is evaporated from the poultry manure deposited on the elements having air permeability with the heated air heated by steam of a boiler, which is supplied from the lower side of the base. Then, the scraper deck is made to reciprocate in the horizontal direction at a constant time interval so as to collect poultry manure (dry manure) having equal to or lower than a predetermined moisture content through the hole portions provided on the lowermost element finally. A technique of dispersing the load that is applied to the scraper deck by the deposited poultry manure so as to make the scraper deck slide stably has been also proposed.

The wet manure collected from the poultry cage is conveyed to the above-mentioned drying apparatus by well-known conveying units such as a belt conveyor and a screw conveyor in combination. For example, the screw conveyor includes a uniaxial screw, a trough (casing), and a rotating mechanism unit. The uniaxial screw is arranged along a conveyance path of the poultry manure. The trough accommodates the screw and axially supports it in a rotatable manner. The rotating mechanism unit rotates the screw in the trough. Spiral screw blades generate a pressing force by rotating the screw in the trough, so that the poultry manure can be conveyed from one end of the trough to the other end thereof along the lengthwise direction (direction of the screw shaft) of the trough. A discharge port of the poultry manure is provided on the other end of the trough, and the poultry manure pressed out by the screw is discharged to the outside of the trough through the discharge port to be fed to the drying apparatus.

The poultry manure that is charged into the trough of the screw conveyor is wet manure having the high moisture content as described above and the moisture content does not change during the conveyance by the screw. In addition, the belt conveyor or the like provided between the poultry cage and the screw conveyor does not also have a function of adjusting the moisture content. Therefore, the poultry manure conveyed to the drying apparatus by the conveying units still has the moisture content as high as equal to or higher than 70%. When the poultry manure is charged into the base in which the plate-like elements are laminated in a state of being separated from each other, it is expected that it takes much time to dry the poultry manure by the drying apparatus. That is to say, when the wet manure having the high moisture content is tried to be dried to have equal to or lower than a predetermined moisture content (for example, equal to or lower than 20%), huge heat energy and much time are required to evaporate the moisture. Therefore, there is a risk that dry efficiency by the drying apparatus lowers. In order to cope with this, processing of adjusting the moisture content of the wet manure so as to lower the moisture content to some extent is performed while it is conveyed from the poultry cage to the drying apparatus.

As is described in detail, processing of mixing the dry manure having a low moisture content into the wet manure collected from the poultry cage at a predetermined ratio during the conveyance to the drying apparatus and conveying the wet manure and the dry manure while agitating and mixing them so as to lower the moisture content of the mixed poultry manure immediately before being charged into the drying apparatus is performed. In this case, a device that adds the dry manure is provided on halfway of the conveyance path of the screw conveyor for conveying the wet manure. With this, the wet manure and the dry manure are mixed appropriately in the screw conveyor. This can suppress the moisture content of the mixed poultry manure to equal to or lower than 50%, for example, thereby shortening the processing time by the drying apparatus and suppressing an energy consumption amount. As the dry manure that is mixed into the wet manure, the poultry manure obtained by extracting apart of the poultry manure on which the drying apparatus has performed the drying processing can be used.

### SUMMARY OF THE INVENTION

The following problem, however, arises in the stirring and transport device for poultry droppings that conveys the poultry manure to the drying apparatus while adjusting the moisture content thereof by using the above-mentioned screw conveyor. That is to say, in general, the screw that is supported in a rotatable manner by the trough for conveying the poultry manure is uniaxial. There arises a possibility that the screw cannot mix the wet manure and the dry manure uniformly. The wet manure and the dry manure entered between the screw blades receive the pressing force by rotation of the screw having the spiral screw blades so as to be conveyed in the predetermined direction. The wet manure and the dry manure between the screw blades do not move largely during the conveyance and are not mixed with the poultry manure around them in many cases. Accordingly, even when the dry manure is added to the wet manure from the downstream side, the uniaxial screw cannot agitate and mix the wet manure and the dry manure sufficiently in some cases. Further, the paste-form wet manure having the high moisture content has a high viscosity, so that it agglutinates by the agitation and masses are formed in the trough in some cases. Even when the dry manure is added to the mass-like wet manure, the powder-form dry manure attaches to the surface of the wet manure only and they cannot be mixed uniformly in some cases. That is to say, there is a possibility that the uniaxial screw conveyor simplifies the movement of the wet manure and the dry manure in the trough and is not appropriate for agitation and mixing. This hardly contributes to improvement in the drying efficiency and improvement in the energy consumption efficiency for the poultry manure fed to the drying apparatus in some cases.

In view of the above-mentioned circumferences, an object of the invention is to provide a stirring and transport device for poultry droppings that can mix wet manure and dry manure uniformly while conveying the wet manure collected from a poultry cage to a drying apparatus and feed the mixed poultry manure of which moisture content has been adjusted to the drying apparatus.

A stirring and transport device for poultry droppings according to an aspect of the invention is mainly configured to “include a first screw having spiral screw blades, a second screw formed to have a shape symmetric to the first screw, a long groove-like trough having a poultry manure conveyance space that axially supports and accommodates the first screw and the second screw such that the first screw and the second screw are arranged in parallel and are rotatable, and conveys poultry manure, a wet manure charge port that is connected to one end side of the trough and through which wet manure collected from a poultry cage is charged into the poultry manure conveyance space, a dry manure charge port that is provided at the downstream side with respect to the wet manure charge port and through which dry manure having a moisture content lower than the wet manure is charged into the poultry manure conveyance space, a poultry manure discharge port that is provided at the other end side of the trough and through which poultry manure obtained by mixing the wet manure and the dry manure is discharged from the poultry manure conveyance space, and a rotating mechanism unit that rotates the first screw and the second screw in rotating directions opposite to each other and conveys the wet manure and the dry manure to the poultry manure discharge port while agitating the wet manure and the dry manure in the poultry manure conveyance space.”

The first screw and the second screw include screw shafts formed into long-axis bar forms and spiral screw blades that are attached to the circumferences of the screw shafts at a defined pitch interval. The second screw is formed to have the shape symmetric to the first screw. That is to say, the screw blades of the second screw are attached such that the spiral direction (for example, right-handed) thereof is opposite to the spiral direction (for example, left-handed) of the screw blades of the first screw. Further, the rotating mechanism unit controls rotation such that the rotating directions of the respective screws arranged in parallel are opposite to each other. That is, the rotating mechanism unit controls rotation such that the second screw rotates in the counterclockwise direction when the first screw rotates in the clockwise direction as observed from the screw shaft direction of the first screw and the second screw. With this, the poultry manure between the first screw and the second screw is conveyed with pressing forces of the screws while repeatedly receiving forces toward the inward directions from the outward directions of the trough and forces toward the outward directions from the inward directions of the trough by the respective screws.

The long groove-like trough includes a bearing for axially supporting the first screw and the second screw arranged in parallel in a rotatable manner and a trough bottom portion is formed in a recess form corresponding to rotation trajectories of the respective screws. Further, the trough includes the poultry manure conveyance space for conveying the poultry manure containing the wet manure and the dry manure. Note that the rotating mechanism unit for rotating the screws can employ a configuration such as a driving motor and a gear box transmitting rotation of a driving motor to the screw shafts. As a unit for transferring the wet manure collected from the poultry cage to the wet manure charge port and a unit for transferring the dry manure to the dry manure charge port, a transfer unit such as a belt conveyor can be used.

With the stirring and transport device for poultry droppings according to the aspect to the invention, the pair of screws having the shapes symmetric to each other are arranged in parallel and are made to rotate in the rotating directions opposite to each other. With this, the particles of poultry manure of two types (wet manure and dry manure) having different moisture contents, which have been charged into the poultry manure conveyance space of the trough, can be mixed evenly and can be discharged toward the drying apparatus through the poultry manure discharge port. In particular, the two screws are used and are made to rotate biaxially, so that the wet manure and the dry manure are mixed uniformly. Further, the rotating directions of the screws are made to be opposite to each other, so that the unevenness of the poultry manure in the poultry manure conveyance space is eliminated. In addition, when the poultry manure is discharged through the poultry manure discharge port, the poultry manure can be discharged in a state where a portion in the vicinity of the center in the width direction of the poultry manure conveyance space is raised in a mountain form.

Further, in the stirring and transport device for poultry droppings according to the aspect of the invention, a configuration in which “the rotating mechanism unit controls rotation rates of the first screw and the second screw independently and changes a rotation rate ratio between the first screw and the second screw that are made to rotate at different rotation rates based on operation time” may be employed in addition to the above-mentioned configuration.

With the stirring and transport device for poultry droppings according to the aspect of the invention, the rotation rates of the first screw and the second screw are controlled independently. With this, an amount of poultry manure in the width direction (corresponding to the direction orthogonal to the conveyance direction of the poultry manure) of the poultry manure conveyance space can be made uneven. For example, when a ratio of the rotation rate between the first screw and the second screw is set to 6:4, an amount of poultry manure that is conveyed by the rotation of the first screw becomes larger. As a result, a part of the poultry manure that is conveyed to the side of the second screw arranged in parallel with the first screw is pressed out. This results in that a larger amount of poultry manure is present at the second screw side in the poultry manure conveyance space unevenly. With this, the movement of the poultry manure in the width direction is applied in addition to the movement thereof in the poultry manure conveyance direction, so that the wet manure and the dry manure are mixed preferably. In addition, the ratio of the rotation rate between the first screw and the second screw is changed based on operation time, so that the above-mentioned action is significant. As a mechanism for controlling the rotation rates of the first screw and the second screw independently, a transmission that controls the rotation rates and the rotating directions of the respective screws in accordance with a gear ratio by using a plurality of driving gears coupled to motor shafts of screw rotation motors, a driving mechanism that controls them with a driving chain or a driving belt bridged between the motor shafts and the screw shafts, and the like can be used.

Further, in the stirring and transport device for poultry droppings according to the aspect of the invention, a configuration in which “the rotating mechanism unit includes a first driving motor that is coupled to a first screw shaft end of the first screw and rotationally drives the first screw, and a second driving motor that is arranged in parallel with the first driving motor, is coupled to a second screw shaft end of the second screw, and rotationally drives the second screw” may be employed in addition to the above-mentioned configuration.

Accordingly, with the stirring and transport device for poultry droppings according to the aspect of the invention, a pair of driving motors that can rotate the first screw and the second screw independently are provided. The first driving motor and the second driving motor are coupled to the respective screw shaft ends and apply rotation to the first screw and the second screw that are axially supported on the trough in the rotationally movable manner, respectively. Further, the respective driving motors are independent, so that the rotation rates of the respective screws can be controlled to be different from each other easily. This makes it possible to set a ratio of the rotation rate between the first screw and the second screw arbitrarily.

With the effect of the stirring and transport device for poultry droppings in the invention, the wet manure and the dry manure can be conveyed from one end to the other end of the trough while being agitated so as to be fed to the drying apparatus by using the pair of screws arranged in parallel in the trough. In particular, the wet manure and the dry manure are mixed uniformly by the biaxial screws and the rotating directions of the screws having the shapes symmetric to each other are opposite to each other. With this, the movements of the wet manure and the dry manure in the poultry manure conveyance space can be complicated, thereby keeping the preferable mixing state.

### BRIEF DESCRIPTION OF THE DRAWINGS

FIG. 1 is a descriptive view for explaining a schematic configuration of a poultry manure drying system including a stirring and transport device for poultry droppings in the embodiment when seen from the above.

FIG. 2 is a descriptive view for explaining the schematic configuration of the poultry manure drying system when seen from the side.

FIG. 3 is a plan view illustrating the stirring and transport device for poultry droppings.

FIG. 4 is a front view illustrating the stirring and transport device for poultry droppings.

FIG. 5 is a right side view illustrating the stirring and transport device for poultry droppings.

FIG. 6 is a cross-sectional view illustrating the stirring and transport device for poultry droppings.

### DESCRIPTION OF THE EMBODIMENTS

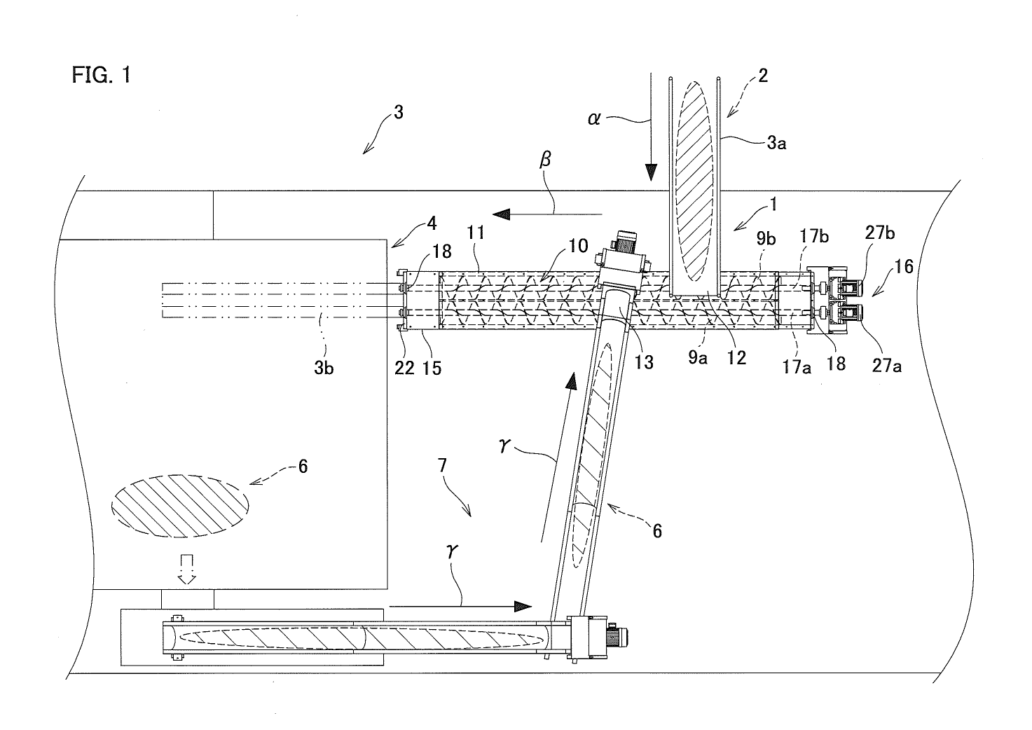

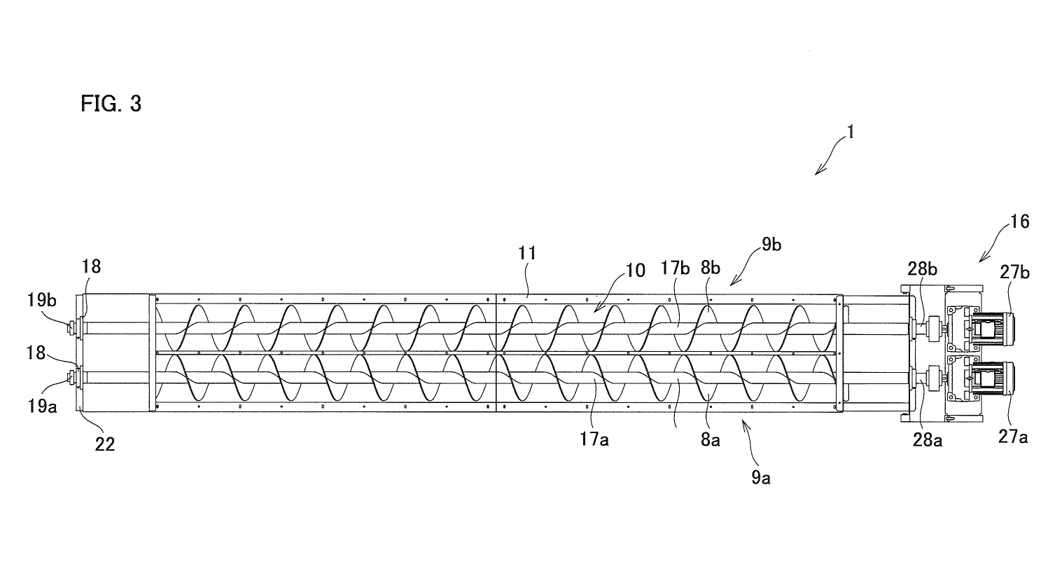

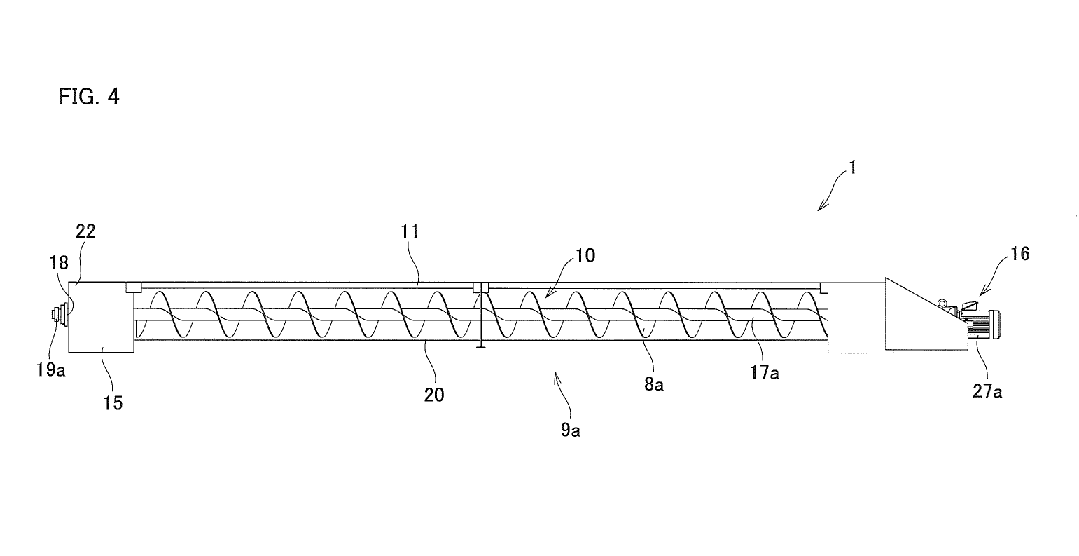

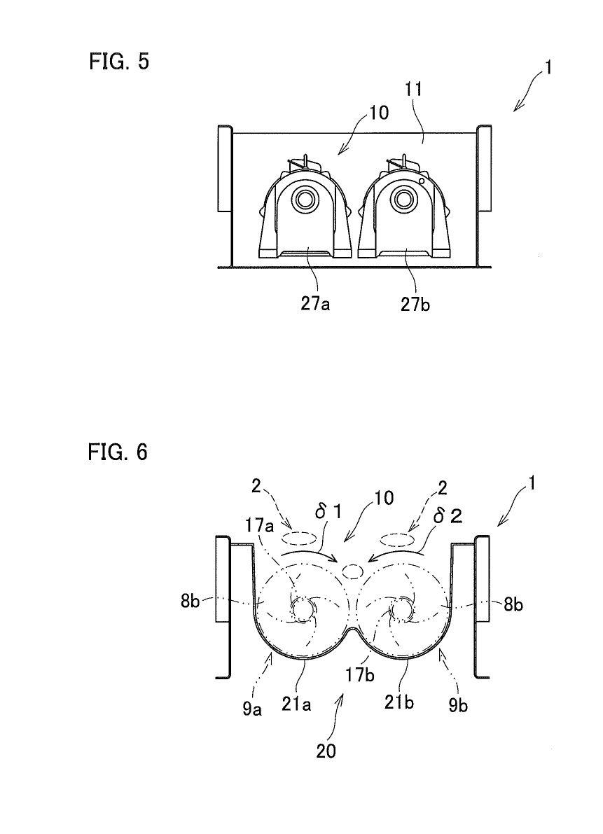

Next, a stirring and transport device for poultry droppings 1 according to an embodiment of the invention is described with reference to FIG. 1 to FIG. 6. In FIG. 1 to FIG. 6, apart of the configuration is not illustrated in order to simplify the description. In FIG. 3 and FIG. 4, a first screw 9a and a second screw 9b are indicated by solid lines, in particular, in order to clarify the configurations thereof.

The stirring and transport device for poultry droppings 1 in the embodiment conveys poultry manure (wet manure 2) having a high moisture content, which has been collected from a poultry cage (not illustrated), to a drying apparatus 4. The poultry cage is a cage for housing and breeding a large number of chickens. The drying apparatus 4 dries the poultry manure by using heated air. The stirring and transport device for poultry droppings 1 constitutes apart of a poultry manure drying system 3. The poultry manure drying system 3 dries the wet manure 2 so as to generate dry manure 6 to be reused as fertilizer or fuel. The poultry manure drying system 3 includes a first conveying conveyor 3a, the stirring and transport device for poultry droppings 1, a second conveying conveyor 3b, the drying apparatus 4, and a dry manure circulation conveying unit 7. The first conveying conveyor 3a conveys the wet manure 2 to the stirring and transport device for poultry droppings 1 in the embodiment from a slope standing in the poultry cage. The wet manure 2 is collected and integrated by a poultry removing system (not illustrated) that is attached to the poultry cage. The stirring and transport device for poultry droppings 1 agitates the wet manure 2 conveyed by the first conveying conveyor 3a with the dry manure 6 while conveying them to the drying apparatus 4, and adjusts a moisture content thereof. The second conveying conveyor 3b conveys poultry manure 5 of which moisture content has been adjusted to the drying apparatus 4. The drying apparatus 4 dries the poultry manure 5 by using the heated air so as to lower the moisture content thereof to a predetermined moisture content. The dry manure circulation conveying unit 7 extracts a part of the dry manure 6 on which the drying apparatus 4 has performed the drying processing and circulates it in order to mix the dry manure 6 with the wet manure 2 in the stirring and transport device for poultry droppings 1.

With this, the moisture content of the wet manure 2 collected from the poultry cage is previously adjusted while the wet manure 2 is conveyed to the drying apparatus 4. Then, the drying apparatus 4 performs the drying processing in a state where the drying efficiency and the energy efficiency are preferable. The poultry manure drying system 1 is provided to be partitioned from a poultry house for breeding the chickens, which is built in the poultry facility. The poultry house and a building in which the poultry manure drying system 1 is provided are connected by the first conveying conveyor 3a. The first conveying conveyor 3a and the second conveying conveyor 3b employ conveying mechanisms using common belt conveyors.

As illustrated in FIG. 1 to FIG. 6, the stirring and transport device for poultry droppings 1 in the embodiment includes the first screw 9a, the second screw 9b, a long groove-like trough 11, a wet manure charge port 12, a dry manure charge port 13, a poultry manure discharge port 15, and a rotating mechanism unit 16. The first screw 9a has spiral screw blades 8a. The second screw 9b is formed to be symmetric to the first screw 9a and has spiral screw blades 8b. The trough 11 axially supports the first screw 9a and the second screw 9b in a rotatable manner in a state where they are arranged in parallel so as to make the shaft directions thereof be in parallel with each other, and has a poultry manure conveyance space 10. The wet manure 2 collected from the poultry cage and the dry manure 6 supplied by the dry manure circulation conveying unit 7 are conveyed to the drying apparatus 4 while being agitated and mixed in the poultry manure conveyance space 10. The wet manure charge port 12 is provided at an upper portion of the trough 11 at the one end side. The wet manure 2 collected and conveyed from the poultry cage by the first conveying conveyor 3a is charged into the poultry manure conveyance space 10 of the trough 11 through the wet manure charge port 12. The dry manure charge port 13 is provided at an upper position at the downstream side (side toward the drying apparatus 4) with respect to the wet manure charge port 12. The dry manure 6 conveyed by the dry manure circulation conveying unit 7 is charged into the poultry manure conveyance space 10 of the trough 11 through the dry manure charge port 13. The poultry manure discharge port 15 is provided on the trough 11 at the other end side. The poultry manure 5 obtained by mixing the wet manure 2 and the dry manure 6 uniformly at a predetermined ratio in the poultry manure conveyance space 10 is discharged from the poultry manure conveyance space 10 and is fed to the second conveying conveyor 3b through the poultry manure discharge port 15. The rotating mechanism unit 16 controls the first screw 9a and the second screw 9b so as to be rotatable in the directions opposite to each other. The rotating mechanism unit 16 can change a ratio of the rotation rate between the first screw 9a and the second screw 9b and switch the ratio of the rotation rate alternately every defined operation time.

The respective configurations of the stirring and transport device for poultry droppings 1 are described in detail. The first screw 9a and the second screw 9b include long bar-shaped screw shafts 17a and 17b and the screw blades 8a and 8b, respectively. The screw shafts 17a and 17b have circular cross-sectional shapes (see, FIG. 6 and the like). The screw blades 8a and 8b are wound at a predetermined pitch interval along the circumferences of the screw shafts 17a and 17b, respectively. As illustrated in FIG. 3 and the like, the winding direction (spiral direction) of the second screw blades 8b of the second screw 9b is set to be opposite to the winding direction of the first blades 8a of the first screw 9a. As a result, the first screw 9a and the second screw 9b have the shapes symmetric to each other. One shaft ends 19a and 19b of the respective screw shafts 17a and 17b of the first screw 9a and the second screw 9b are axially supported on bearings 18 of the trough 11, which will be described later, in a rotatable manner. The other shaft ends thereof are coupled to motor shafts 28a and 28b of a first driving motor 27a and a second driving motor 27b, which will be described later, respectively. This makes it possible to control the rotation rates and the rotating directions of the first screw 9a and the second screw 9b independently in accordance with the rotation driving of the driving motors 27a and 27b, respectively.

The long groove-like trough 11 has the poultry manure conveyance space 10. The poultry manure conveyance space 10 accommodates the first screw 9a and the second screw 9b as described above and the wet manure 2 and the dry manure 6 are agitated and conveyed in the poultry manure conveyance space 10. A trough bottom portion 20 of the trough 11 includes semicircular portions 21a and 21b. The semicircular portions 21a and 21b are hollowed in recess forms so as to correspond to rotational trajectories of the screw blades 8a and 8b of the first screw 9a and the second screw 9b arranged in parallel, respectively. A bearing side surface portion 22 is formed on the trough 11 at the other end side (corresponding to the left side of a paper plain in FIG. 3). The bearings 18 for axially supporting the first screw 9a and the second screw 9b arranged in parallel are provided on the bearing side surface portion 22. The respective driving motors 27a and 27b of the rotating mechanism unit 16 are installed on the trough 11 at one end side (corresponding to the right side of the paper plain in FIG. 3). Further, the upper portion of the trough 11 is opened and is provided with the wet manure charge port 12 and the dry manure charge port 13 for charging the wet manure 2 and the dry manure 6 into the poultry manure conveyance space 10, respectively, at one end side. In addition, a trough cover (not illustrated) for covering the upper surface of the trough may be installed from the upstream side with respect to the position at which the dry manure charge port 13 is provided to the other end of the trough 11 in order to prevent foreign matters and the like from mixing into the poultry manure conveyance space 10.

The poultry manure discharge port 15 for discharging the agitated and conveyed poultry manure 5 from the poultry manure conveyance space 10 and delivering it to the second conveying conveyor 3b is provided on the trough 11 at the other end side. Further, the trough 11 is installed such that the lengthwise direction of the trough is inclined with respect to an installation surface 23 of the poultry manure drying system 3. One end side of the trough 11 is supported by a one-end supporting leg portion 24a erected from the installation surface. The other end side of the trough 11 is coupled to and supported by a the-other-end-supporting leg portion 24b that is longer than the above-mentioned one-end supporting leg portion 24a. As a result, the other end side is higher than the one end side of the trough 11 and the poultry manure 5 that is conveyed through the poultry manure conveyance space 10 is conveyed obliquely upward along the inclination of the trough 11.

The rotating mechanism unit 16 includes the first driving motor 27a, the second driving motor 27b, a rotation controller, and a memory. The first driving motor 27a is coupled to one end side of the first screw shaft 17a of the first screw 9a through the motor shaft 28a. The second driving motor 27b is coupled to one end side of the second screw shaft 17b of the second screw 9b through the motor shaft 28b. The rotation controller controls rotation of the second driving motor 27a and the second driving motor 27b independently. The rotation controller is a processor that electrically controls the rotation of the first driving motor 27a and the second driving motor 27b, and is not illustrated. With this, the first screw 9a and the second screw 9b that are axially supported by the trough 11 are controlled by the rotation controller independently. The rotation rates, the ratio of the rotation rate, the change based on the operation time, and the like of the first screw 9a and the second screw 9b can be set arbitrarily. Further, in the stirring and transport device for poultry droppings 1 in the embodiment, the processor sets the ratio of the rotation rate between the first screw 9a and the second screw 9b in the poultry manure conveyance space 10 so as to satisfy “first screw:second screw=6.4” at an operation starting time and has a function of alternately switching the ratio to “first screw:second screw=4:6” every predetermined operation time (for example, 30 seconds) in accordance with a control program that is stored in the memory of the rotating mechanism unit 16 previously. Further, as illustrated in FIG. 6, the rotating mechanism unit 16 controls such that the rotating directions (first rotating direction 81, second rotating direction 82) of the first screw 9a and the second screw 9b are opposite to each other.

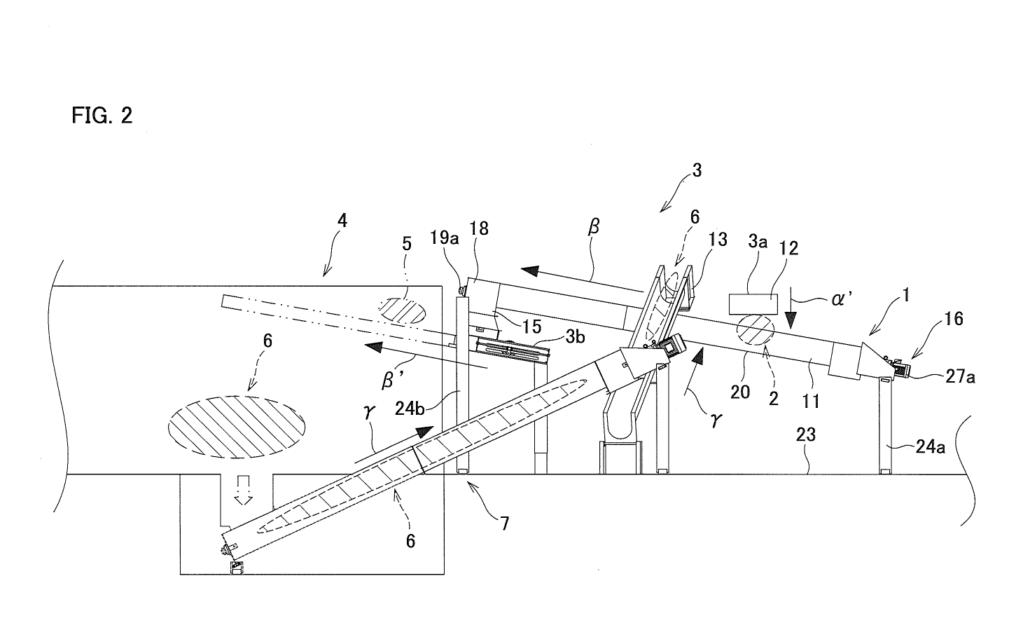

On the other hand, the second conveying conveyor 3b as a part of the configuration of the poultry manure drying system 3 receives the poultry manure 5 of which moisture content has been adjusted by the stirring and transport device for poultry droppings 1 at a position opposed to the poultry manure discharge port 15. Then, the second conveying conveyor 3b conveys the poultry manure 5 obliquely upward to the upper portion of the drying apparatus 4 that performs the drying processing by the belt conveyor. The drying apparatus 4 is configured by a plurality of elements, a scraper deck, a heated air generation and supply device, and the like (any of them are not illustrated). The drying apparatus 4 has a function of transferring the poultry manure charged from the upper portion of the drying apparatus 4 to an element at a lower position gradually while pressing out the poultry manure and evaporating moisture contained in the poultry manure 5 by using heat energy of heated air heated by steam of a boiler. Finally, when the poultry manure is discharged from the element at the lower stage of the drying apparatus 4, the dry manure 6 having the low moisture content is generated and becomes capable of being reused as fertilizer or the like. As illustrated in FIG. 1 and FIG. 2, apart of the generated dry manure 6 is extracted to be conveyed to the stirring and transport device for poultry droppings 1 through the dry manure circulation conveying unit 7. The dry manure circulation conveying unit 7 conveys a part of the dry manure 6 extracted from the lower position of the drying apparatus 4 to the position of the dry manure charge port 13 of the stirring and transport device for poultry droppings 1 in the horizontal direction and the height direction (FIG. 1 and FIG. 2). The dry manure circulation conveying unit 7 mainly includes a band-like conveyor belt, a plurality of rollers that abut against a belt inner surface of the conveyor belt, a roller rotation motor that rotationally drives the rollers, and the like.

Next, described is an example of conveyance of the poultry manure 5 of which moisture content has been adjusted to the drying apparatus 4 by using the stirring and transport device for poultry droppings 1 in the embodiment. First, the stirring and transport device for poultry droppings 1 and the poultry manure drying system 3 are made into operating states. Then, the pair of first screw 9a and the second screw 9b that are arranged in parallel and are axially supported in the poultry manure conveyance space 10 are made to rotate at predetermined rotation rates based on a control signal from the rotation controller of the rotating mechanism unit 16 of the stirring and transport device for poultry droppings 1. In this case, as illustrated in FIG. 6, the first screw 9a is controlled to rotate in the clockwise direction (first rotating direction 81) whereas the second screw 9b is controlled to rotate in the counterclockwise direction (second rotating direction 82). Further, the ratio of the rotation rate between the first screw 9a and the second screw 9b is set to “6:4” as an initial condition when the operation is started. The rotating mechanism unit 16 includes the first driving motor 27a and the second driving motor 27b independently, thereby controlling the ratio of the rotation rate easily.

In a state where the screws 9a and 9b in the poultry manure conveyance space 10 rotate under predetermined rotating conditions, the first conveying conveyor 3a conveys the wet manure 2 collected from the poultry cage to the wet manure charge port 12 (see, an arrow α in FIG. 1 and the like). Note that the first conveying conveyor 3a is the belt conveyor. The wet manure 2 that has reached the conveyor end (wet manure charge port 12) drops by its own weight (see, arrow α′ in FIG. 2), and is charged into the poultry manure conveyance space 10.

The wet manure 2 charged into the poultry manure conveyance space 10 is conveyed in a pressed-out manner from one end side to the other end side of the trough 11 with the pressing forces generated by the pair of screws 9a and 9b (see, arrow β in FIG. 1 and FIG. 2). In this case, the pair of screws 9a and 9b rotate in the opposite directions to each other, so that a force of moving the wet manure 2 toward between the screws 9a and 9b at the center of the trough 11 acts in the vicinity of the upper portion of the poultry manure conveyance space 10 from both the outer directions (corresponding to the right-left direction in FIG. 6) of the trough 11.

As a result, the particles of wet manure 2 conveyed from both the outer directions hit against one another to be sucked into between the screws 9a and 9b while being mixed with one another. Further, the particles of wet manures 2 sucked into between the screws 9a and 9b are conveyed to the vicinity of the center lower portion in the poultry manure conveyance space 10, and then, are separated in both the outer directions. With this, the particles of the wet manure 2 are conveyed to the other end side in the poultry manure conveyance space 10 while repeatedly hitting against and being separated from one another by the biaxial screws 9a and 9b.

At the same time as the charging of the wet manure 2 through the wet manure charge port 12, the dry manure 6 is charged into the poultry manure conveyance space 10 through the dry manure charge port 13 provided at the further downstream position. Accordingly, when the wet manure 2 is conveyed to the drying apparatus 4 while being agitated by the screws 9a and 9b so as to reach the position just under the dry manure charge port 13, the dry manure 6 drops from the upper side of the wet manure 2 to be charged into the poultry manure conveyance space 10. The charge ratio between the wet manure 2 and the dry manure 6 that are charged through the wet manure charge port 12 and the dry manure charge port 13, respectively, is not particularly limited and can be set arbitrarily in accordance with the moisture content of the wet manure 2 collected from the poultry cage. With this, the wet manure 2 and the dry manure 6 are present in the poultry manure conveyance space 10. In this case, the pair of screws 9a and 9b rotate in the opposite directions to each other, so that the wet manure 2 and the dry manure 6 move in the manner as described above for the wet manure 2. As a result, immediately after the dry manure 6 is charged into the poultry manure conveyance space 10, they are not mixed uniformly but “hitting” and “separation” as described above are repeated so as to obtain the poultry manure 5 in which the wet manure 2 and the dry manure 6 are mixed evenly. That is to say, the particles of poultry manure of two types (wet manure 2 and dry manure 6) having different moisture contents are agitated while being conveyed, so that the moisture content of the obtained poultry manure 5 is adjusted in accordance with the mixture ratio of them. Note that in the stirring and transport device for poultry droppings 1 in the embodiment, the moisture content of the poultry manure 5 obtained by mixing the wet manure 2 and the dry manure 6 is adjusted to be equal to or lower than approximately 50%.

As described above, in the embodiment, the rotating mechanism unit 16 sets the ratio of the rotation rate between the first screw 9a and the second screw 9b immediately after the operation is started to “6:4”. As a result, the conveyance speed and the conveyance amount of the poultry manure 5 are uneven in the width direction (corresponding to the up-down direction of the paper plain in FIG. 3) of the poultry manure conveyance space 10 (trough 11). To be specific, the conveyance speed of the poultry manure 5 in which the wet manure 2 and the dry manure 6 are mixed is faster at the side of the first screw 9a of which rotation rate is high and the conveyance amount thereof per unit time is large. On the other hand, the conveyance speed of the poultry manure 5 is slower at the side of the second screw 9b of which rotation rate is low and the conveyance amount thereof per unit time is small. As a result, an amount of the poultry manure 5 hitting at the center position closer to the upper portion in the poultry manure conveyance space 10, which is pressed out from the side of the first screw 9a to the side of the second screw 9b, becomes large. That is to say, the poultry manure 5 can be moved in the width direction of the trough 11. With this, the poultry manure 5 not only is conveyed in the poultry manure conveyance direction β by the pair of screws 9a and 9b simply while being agitated but also can be moved in the width direction of the trough 11. This makes it possible to complicate the movement of the poultry manure 5 in the poultry manure conveyance space 10. As a result, the wet manure 2 and the dry manure 6 are mixed efficiently for a short period of time.

In the stirring and transport device for poultry droppings 1 in the embodiment, the rotation controller of the rotating mechanism unit 16 performs switching control. With the switching control, the ratio of the rotation rate between the first screw 9a and the second screw 9b is switched alternately every previously defined operation time. To be specific, the ratio of the rotation rate between the first screw 9a and the second screw 9b is changed in the manner of “6:4” to “4:6” to “6:4” every predetermined operation time (for example, every 30 seconds). This makes it possible to further complicate the movement of the poultry manure 5 in the poultry manure conveyance space 10 and achieve the preferable agitation state of the wet manure 2 and the dry manure 6 more effectively. In the stirring and transport device for poultry droppings 1 in the embodiment, time (conveyance retention time) until the agitated and mixed poultry manure 5 is discharged through the poultry manure discharge port 15 at the other end side since the wet manure 2 has been charged through the wet manure charge port 12 is set to approximately 60 seconds. Based on this, the charged wet manure 2 and dry manure 6 experience the switching processing of the ratio of the rotation rate between the right and left screws 9a and 9b at least once during the conveyance.

Thereafter, the poultry manure 5 that has reached the other end side of the trough 11 and in which the wet manure 2 and the dry manure 6 have been mixed uniformly is fed out to the second conveying conveyor 3b through the poultry manure discharge port 15, and is conveyed toward the upper portion of the drying apparatus 4 (see, arrow β′ in FIG. 2). As described above, the poultry manure 5 that is discharged through the poultry manure discharge port 15 after passing through the stirring and transport device for poultry droppings 1 in the embodiment has the moisture content of equal to or lower than approximately 50% because the moisture contents of the wet manure 2 and the dry manure 6 have been adjusted. Therefore, the drying apparatus 4 that receives the poultry manure 5 from the second conveying conveyor 3b can perform the drying processing on the poultry manure 5 with reduced heat energy consumption for evaporating moisture.

The drying apparatus 4 performs the drying processing, so that the poultry manure 5 having the moisture content of approximately 50% is converted to the dry manure 6 having the moisture content of equal to or lower than 20% finally. Then, the dry manure 6 is reused as fertilizer or the like. At this time, a part of the dry manure 6 is extracted and is charged into the poultry manure conveyance space 10 through the dry manure charge port 13 of the stirring and transport device for poultry droppings 1 through the dry manure circulation conveying unit 7 (see, arrow γ in FIG. 1 and FIG. 2) as described above. With this, the dry manure 6 necessary for adjusting the moisture content of the wet manure 2 can be supplied from a part thereof processed by the drying apparatus 4, so that the poultry manure drying system 3 can be operated efficiently.

As described above, the stirring and transport device for poultry droppings 1 in the embodiment is incorporated in the poultry manure drying system 3 and mixes and agitates the wet manure 2 having the high moisture content and the dry manure 6 having the low moisture content at an appropriate ratio so as to adjust the moisture content previously at a stage before they are charged into the drying apparatus 4. With this, the dry time in the drying processing that is performed by the drying apparatus 4 can be shortened so as to stabilize the energy efficiency. In particular, unlike the case using the conventional uniaxial screw conveyor, the pair of first screw 9a and second screw 9b having the shapes symmetric to each other are arranged in parallel and are made to rotate in the opposite rotating directions. This enables the components of two types of the wet manure 2 and the dry manure 6 to be mixed efficiently and uniformly. Therefore, the moisture content of the poultry manure 5 that is discharged through the poultry manure discharge port 15 is even. As a result, the energy efficiency can be made more stable. In addition, the moisture content can be lowered efficiently only by mixing the particles of poultry manure of two types (wet manure 2 and dry manure 6) having different moisture contents. Further, as the dry manure 6 to be added, a part of dried poultry manure that has been fed out through the stirring and transport device for poultry droppings 1 and produced by the drying apparatus 4 can be applied and circulated. This makes it possible to perform an operation efficiently.

Hereinbefore, the invention has been described by taking the preferable embodiment as an example. However, the invention is not limited to the embodiment and various improvements and changes in design can be made in a range without departing from the scope of the invention as will be described below.

That is to say, the stirring and transport device for poultry droppings 1 in the embodiment switches the ratio of the rotation rate between the pair of screws 9a and 9b between “6:4” and “4:6” alternately. However, the values of the ratio are not limited thereto and can be arbitrarily changed in a range from “10:0” to “0:10”. In other words, rotation of the screw 9a or 9b may be stopped temporarily in accordance with unevenness of the poultry manure in the poultry manure conveyance space 10 in the width direction. Further, the ratio of the rotation ratio may not be made different depending on the nature of the poultry manure as a conveyance target and the ratio of the rotation rate of “1:1” may be employed. In addition, in the stirring and transport device for poultry droppings 1 in the embodiment, the trough 11 is arranged to be inclined. However, the trough 11 is not limited thereto and may be installed along the horizontal direction in accordance with the shape of the second conveying conveyor 3b or the drying apparatus 4. The poultry manure drying system 3 is an example for explaining the configuration of the stirring and transport device for poultry droppings 1 in the embodiment and the configuration and the like thereof are not limited thereto.

What is claimed is:

1. A stirring and transport device for poultry droppings comprising:
a first screw having spiral screw blades;
a second screw formed to have a shape symmetric to the first screw;
a long groove-like trough having a poultry manure conveyance space that axially supports and accommodates the first screw and the second screw such that the first screw and the second screw are arranged in parallel and are rotatable, and conveys poultry manure;
a wet manure charge port that is connected to one end side of the trough and through which wet manure collected from a poultry cage is charged into the poultry manure conveyance space;
a dry manure charge port that is provided at the downstream side with respect to the wet manure charge port and through which dry manure having a moisture content lower than the wet manure is charged into the poultry manure conveyance space;
a poultry manure discharge port that is provided at the other end side of the trough and through which poultry manure obtained by mixing the wet manure and the dry manure is discharged from the poultry manure conveyance space; and
a rotating mechanism unit that rotates the first screw and the second screw in rotating directions opposite to each other and conveys the wet manure and the dry manure to the poultry manure discharge port while agitating the wet manure and the dry manure in the poultry manure conveyance space.

2. The stirring and transport device for poultry droppings according to claim 1, wherein
the rotating mechanism unit controls rotation rates of the first screw and the second screw independently and changes a rotation rate ratio between the first screw and the second screw that are made to rotate at different rotation rates based on operation time.

3. The stirring and transport device for poultry droppings according to claim 1, wherein
the rotating mechanism unit includes:
a first driving motor that is coupled to a first screw shaft end of the first screw and rotationally drives the first screw. and
a second driving motor that is arranged in parallel with the first driving motor, is coupled to a second screw shaft end of the second screw, and rotationally drives the second screw.

4. The stirring and transport device for poultry droppings according to claim 2, wherein
the rotating mechanism unit includes:
a first driving motor that is coupled to a first screw shaft end of the first screw and rotationally drives the first screw; and
a second driving motor that is arranged in parallel with the first driving motor, is coupled to a second screw shaft end of the second screw, and rotationally drives the second screw.
